(19) United States
(12) Patent Application Publication
(10) Pub. No.: US 2023/0271484 A1
(43) Pub. Date: Aug. 31, 2023

(54) GLASS PLATE WITH RESIN FRAME FOR VEHICLE WINDOW AND METHOD FOR PRODUCING GLASS PLATE WITH RESIN FRAME

(71) Applicant: AGC Inc., Tokyo (JP)

(72) Inventors: Kazuhiro TAKAHASHI, Tokyo (JP); Hayato KATO, Tokyo (JP)

(73) Assignee: AGC Inc., Tokyo (JP)

(21) Appl. No.: 18/143,540

(22) Filed: May 4, 2023

Related U.S. Application Data
(63) Continuation of application No. PCT/JP21/39859, filed on Oct. 28, 2021.

(30) Foreign Application Priority Data
Nov. 6, 2020 (JP) 2020-185634

(51) Int. Cl. B60J 1/00; B29C 45/14

(52) U.S. Cl. CPC B60J 1/007; B29C 45/14434; B29C 45/14377; B29C 45/14688; B29L 2031/3005

(57) ABSTRACT

A glass plate with a resin frame for a vehicle window, includes a glass plate; a resin frame disposed on a peripheral edge area of the glass plate; and a decorative molding disposed on the resin frame; wherein the resin frame is molded to the glass plate and the decorative molding as one unit; and wherein a spacer is disposed between the resin frame and the decorative molding, the spacer being solid at room temperature.

This application is a continuation of PCT Application No. PCT/JP2021/039859, filed on Oct. 28, 2021, which is based upon and claims the benefit of priority from Japanese Patent Application No. 2020-185634 filed on Nov. 6, 2020. The contents of those applications are incorporated herein by reference in their entireties.

### TECHNICAL FIELD

The present invention relates to a glass plate with a resin frame for a vehicle window, the resin frame having a decorative molding, and a process for producing such a glass plate with a resin frame.

### BACKGROUND ART

Among the glass plates for a vehicle window glass, in particular, automobile glass plates, such as sidelites fixed to a vehicle window opening, have a resin frame integrally disposed to a peripheral edge area of a glass plate so as to fill the gap between the glass plate and the vehicle window opening in many cases. The resin frame serves not only to fix the glass plate to the vehicle window opening and seal the vehicle window opening but also to improve the cosmetic appearance of the glass plate.

The resin frame is integrally disposed to the glass plate by, e.g., applying a primer (adhesive) to the peripheral edge area of the glass plate, followed by placing the glass plate in a mold and injecting a molten resin into the cavity of the mold. This process produces a glass plate with a resin frame, which has the resin frame integrally disposed to the peripheral edge area of the glass plate. The applicant discloses this type of glass plate with a resin frame (available under registered trademark “MAW” and in the product name of “Module Assy Window”) in, e.g., Patent Documents 1 and 2 listed below.

Further, on a surface of a resin frame which is visually recognizable from outside, a decorative molding made of a metal or a resin (also called “bezel”) is provided for the purpose of decorating or reinforcing the resin frame in some cases (see Patent Documents 2 and 3 listed below).

Patent Documents 2 and 3 propose a window glass with a bezel free from the generation of a “creak sound”, focusing the “creak sound” generated by a gap between the bezel and the frame. Patent Document 1 discloses that a nylon-based thermosetting adhesive layer is formed in liquid form on contacting surfaces of a bezel and a frame and is then thermoset. Patent Document 2 discloses that a layer made of an oily liquid material, a material having flowability, or a semi-solid material is formed on contacting surfaces of a bezel and a frame and is then thermoset.

### PRIOR ART DOCUMENTS

### Patent Documents

Patent Document 1: JP-A-2008-270021
Patent Document 2: JP-A-2007-1535
Patent Document 3: JP-A-2007-15555

### DISCLOSURE OF INVENTION

### Technical Problem

When a gap is formed between a bezel and a frame as described above, another problem is caused in addition to the problem of the above-mentioned “creak sound” (hereinafter, also called a peeling sound). Specifically, when a bezel is pressed against the frame, the bezel is easily deformed to keep from obtaining a feeling of rigidity.

In order to avoid the latter problem, Patent Document 1 proposes the use of a thermosetting adhesive. Nevertheless, this proposal permits the decorative molding to be deformed by the bonding force of the thermosetting adhesive, following the heat shrinkage of the frame (so-called “sink marks”), which causes a problem in that the cosmetic appearance of the decorative molding on a vehicle exterior surface is deteriorated. This distortion is more remarkable as the decorative molding has a greater width.

In contrast, Patent Document 2 proposes the use of, e.g., an oily liquid material. This proposal permits the liquid material to adhere to a glass surface by the flow of a molten resin injected into the mold (according to the flow rate and the pressure of the molten resin) in some cases. In such cases, a problem is caused in that the glass surface and the resin frame is subjected to adhesive failure.

As described above, the window glass with a bezel proposed by each of Patent Documents 2 and 3 has a problem in terms of quality.

The present invention has been made under these circumstances. The present invention has an object to provide a glass plate with a resin frame for a vehicle window, having good quality, and a process for producing such a glass plate with a resin frame.

### Solution to Problem

According to one mode of the present invention, in order to solve the problem addressed by the present invention, there is provided a glass plate with a resin frame for a vehicle window, which includes a glass plate; a resin frame disposed on a peripheral edge area of the glass plate; and a decorative molding disposed on the resin frame; wherein the resin frame is molded to the glass plate and the decorative molding as one unit; and wherein a spacer is disposed between the resin frame and the decorative molding, the spacer being solid at room temperature.

According to another mode of the present invention, in order to solve the problem addressed by the present invention, there is provided a process for producing a glass plate with a resin frame for a vehicle window, the resin frame being molded to the glass plate and a decorative molding as one unit, which includes preparing the decorative molding so as to have a first surface and a second surface opposite to the first surface; attaching a spacer to the second surface of the decorative molding, the spacer being solid at room temperature; placing the decorative molding in a mold such that the first surface of the decorative molding faces the mold; placing the glass plate in the mold; and injecting a molten resin into a cavity space in the mold to produce the glass plate with a resin frame for a vehicle window such that the spacer is disposed between the resin frame and the decorative molding

### Advantageous Effects of Invention

In accordance with these modes of the present invention, it is possible to provide a glass plate with a resin frame for a vehicle window, having good quality, and a process for producing such a glass plate with a resin frame.

### BRIEF DESCRIPTION OF DRAWINGS

FIG. 1 is a plan view of the glass plate with a resin frame according to an embodiment of the present invention, seen from a vehicle exterior side.

FIG. 2 is a cross-sectional view of the glass plate with a resin frame illustrated in FIG. 1, taken along line II-II of FIG. 1.

FIG. 3 is a cross-sectional view of a mold for producing the glass plate with a resin frame illustrated in FIG. 1.

FIG. 4 is a flow chart illustrating a production process for the glass plate with a resin frame illustrated in FIG. 1.

FIG. 5 is a cross-sectional view illustrating a modification of the mold.

FIG. 6 is a cross-sectional view of the glass plate with a resin frame according to a first modification.

FIG. 7 is a cross-sectional view of the glass plate with a resin frame according to a second modification.

FIG. 8 is a cross-sectional view of the glass plate with a resin frame according to a third modification.

FIG. 9 is a cross-sectional view of the glass plate with a resin frame according to a fourth modification.

FIG. 10 is a front view of the decorative molding according to the fourth modification, seen from a vehicle interior side.

FIG. 11 is a front view of the decorative molding according to another example of the fourth modification, seen from a vehicle interior side.

### DESCRIPTION OF EMBODIMENTS

Now, embodiments of the glass plate with a resin frame for a vehicle window and the process for producing such glass plate with a resin frame according to the present invention will be described in reference to the accompanying drawings.

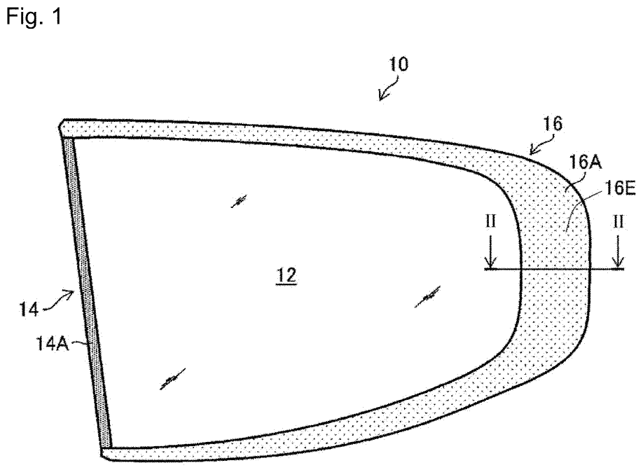

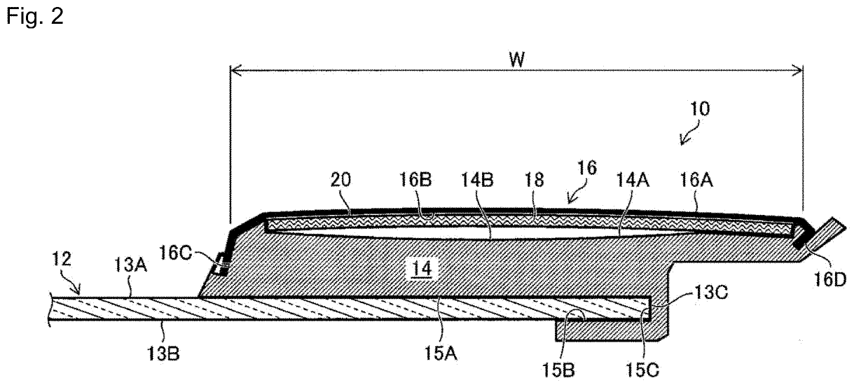

FIG. 1 is a plan view of the glass plate with a resin frame for a vehicle window 10 produced by the process for producing such glass plate with a resin frame according to an embodiment of the present invention, which is seen from a vehicle exterior side. FIG. 2 is a cross-sectional view of the glass plate with a resin frame 10 illustrated in FIG. 1, taken along line II-II of FIG. 1. In the accompanying drawings, respective parts or members are illustrated in an exaggerated size, not a real size, in order to readily understand the present invention. In particular, a “spacer” and a “sink mark portion of a resin frame” that are described later, are illustrated in exaggeration.

Glass Plate with Resin Frame

The glass plate with a resin frame for a vehicle window 10 illustrated in FIGS. 1 and 2 is applicable to a rear quarter glass of an automobile, as one example. The glass plate with a resin frame 10 includes a glass plate 12, a resin frame 14 disposed on a peripheral edge area of the glass plate 12, and a decorative molding 16 disposed on a surface 14A of the resin frame 14. The resin frame 14 is molded to the glass plate 12 and the decorative molding 16 as one unit. The surface 14A of the resin frame 14 is a surface that faces toward a vehicle exterior side and functions as a cosmetic surface of the glass plate with a resin frame 10 when the glass plate with a resin frame 10 is fixed to a vehicle window opening (not shown).

Glass Plate

The glass plate 12 illustrated in FIG. 1 is formed in a substantially square shape as seen in plan view. It should be noted that the shape of the glass plate 12 is not limited to a substantially square shape, and the shape may be a substantially triangular shape or another shape. The glass plate 12 may be made of inorganic glass or organic glass. As the inorganic glass, for example, soda-lime glass, aluminosilicate glass, borosilicate glass, alkali-free glass or quartz glass is applicable without any limitation. Among them, soda-lime glass may be particularly preferable from the viewpoint of production cost and moldability. There is no particular limitation to how to form the glass plate 12. For example, when the glass plate is made of inorganic glass, the glass plate may be preferably formed by a float process or the like.

When the glass plate 12 is made of inorganic glass, the glass plate 12 may be made of either non-tempered glass or tempered glass. The non-tempered glass is one that is produced by forming molten glass in a plate shape and annealing the formed molten glass. The tempered glass is one that is produced by forming a compressive stress layer in the surface of non-tempered glass, and may be either glass tempered by air quenching, or chemically tempered glass.

When the tempered glass is physically tempered glass (such as glass tempered by air quenching), the glass surface may be tempered by, for example, conducting an operation except annealing, so as to quench a glass plate uniformly heated for bending, from a temperature close to its softening point such that a temperature difference is generated between the glass surface and the inside of the glass to form a compressive stress layer in the glass surface. In contrast, when the tempered glass is chemically tempered glass, the glass surface may be tempered by, for example, causing a compressive stress in the glass surface by ion exchange treatment or the like after completion of a bending operation. Or glass that absorbs ultra-violet rays or infrared rays may be used. Although the tempered glass may be preferably transparent, a glass plate that is colored to such a degree not to impair transparency may be used.

The glass plate 12 may be formed in a single bent shape bent only in a single direction or a compound bent shape bent in two directions (for example, in both of a certain direction and a direction orthogonal to the certain direction). In order to bend the glass plate 12, the glass plate may be bent by gravity bending, press bending, roller bending or the like. When the glass plate 12 is bent so as to have a certain radius of curvature, the glass plate 12 may have a radius of curvature set at 1,000 to 100,000 mm.

The glass plate 12 may be a single glass plate. The glass plate 12 may be made of laminated glass wherein at least two glass plates are bonded together via an interlayer, for example. The interlayer of the laminated glass may be made of a known thermoplastic resin film of polyvinyl butyral (PVB) or an ethylene-vinyl acetate copolymer resin (EVA), for example. The interlayer of the laminated glass may be transparent or colored. The interlayer may have two or more layers.

When the glass plate 12 is made of laminated glass, glass plates, which are positioned on an outer side and on an inner side after the glass plate 12 is mounted to a vehicle, may have the same thickness as each other or different thicknesses from each other. The glass plate that is positioned on the outer side after the glass plate 12 is mounted to the vehicle may have a thickness of preferably at least 1.0 mm and at most 3.0 mm. When the glass plate positioned on the outer side has a thickness of at least 1.0 mm, the glass plate has a sufficient strength in terms of resistance against a flipped stone or the like. When the glass plate positioned on the outer side has a thickness of at most 3.0 mm, the laminated glass is prevented from having an excessively heavy weight, which is preferable in terms of mileage of the vehicle. The glass plate positioned on the inner side may have a thickness of preferably at least 0.3 mm and at most 2.3 mm. When the glass plate positioned on the inner side has a thickness of at least 0.3 mm, it is possible to have excellent handling. When the glass plate positioned on the inner side has a thickness of at most 2.3 mm, the laminated glass is prevented from having an excessively heavy weight. When the thickness of each of the glass plates positioned on the outer side and the inner side has a thickness of preferably at most 1.8 mm, the glass plate 12 has not only a sufficient weight reduction but also a sufficient sound insulation, which is advantageous. When the glass plate positioned on the inner side has a thickness of at most 1.0 mm, the glass plate positioned on the inner side may be made of chemically tempered glass. When the glass plate positioned on the inner side is made of chemically tempered glass, the chemically tempered glass may have a compressive stress value of preferably at least 300 MPa in the glass surface and a compressive stress layer formed therein so as to have a depth of preferably at least 2 μm.

When the glass plate 12 is a single glass plate, the glass plate may be made of preferably glass tempered by air quenching. In this case, the glass plate 12 may have a thickness of preferably at least 1.8 mm and at most 5.0 mm.

When the glass plate 12 is made of organic glass, a transparent resin, such as polycarbonate or acrylic resin (for example, polymethyl methacrylate) may be mentioned as the material for the organic glass.

Resin Frame

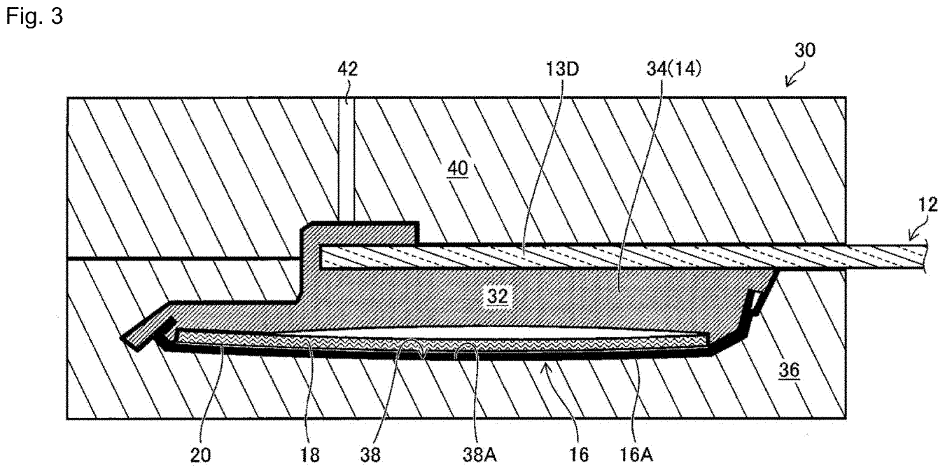

The resin frame 14 is disposed so as to surround the entire periphery of the glass plate 12 in one example. The material for the resin frame 14 may be, for example, a synthetic resin, such as polyvinyl chloride (PVC), or thermoplastic elastomer (TPE). The resin frame 14 may be disposed on the glass plate 12 by placing the glass plate 12 and the decorative molding 16 in a mold 30 having a cavity corresponding to the shape of the resin frame 14 (see FIG. 3), and injecting the above-mentioned synthetic resin (molten synthetic resin) into the cavity.

The resin frame 14 according to this embodiment has a so-called three-side molding including three inner surfaces 15A, 15B and 15C configured to be in touch with an outer side surface 13A, an inner side surface 13B and an end surface 13C of the glass plate 12 as illustrated in FIG. 2. When the glass plate with a resin frame 10 illustrated in FIG. 1 is seen in front view, the resin frame 14 has a thickness of at least 2.5 mm as one example, in an area thereof overlapping with the decorative molding 16 described later. The resin frame 14 having such a thickness ensures a rigidity required for the resin frame 14. The upper limit of the thickness of the resin frame 14 may be properly set according to the weight acceptable for the glass plate with a resin frame 10 as a whole.

Decorative Molding

The decorative molding 16 has, for example, an elongated or frame-like shape as seen in plan view, and is disposed along the surface 14A of the resin frame 14. When the decorative molding 16 is disposed on the surface 14A of the resin frame 14, the decorative molding 16 includes a front surface 16A exposed as a cosmetic surface from the surface 14A of the resin frame 14, a rear surface 16B directed to the surface 14A of the resin frame 14, and both edge portions 16C and 16D embedded in the resin frame 14. The front surface 16A functions as a first surface of the resin frame 14 while the rear surface 16B functions as a second surface of the resin frame 14. In FIG. 2, the decorative molding 16 has a width size W which corresponds to the distance (length) between the edge portion 16C and the edge portion 16D except the edge portion 16C and the edge portion 16D per se being both bent. The decorative molding 16 may have a width size W of preferably at least 30 mm as one example. The decorative molding 16 having such a width size W ensures a sufficient area for the front surface 16A functioning as a cosmetic surface, improving the cosmetic appearance of the glass plate with a resin frame 10.

The decorative molding 16 may be formed by press molding, extrusion or pultrusion using a metal material, or may be formed by extrusion, pultrusion or injection molding using a plastic material. Examples of the metal material include stainless steel, iron, steel and aluminum. Examples of the plastic material include a polyethylene resin, a polypropylene resin, an ethylene-vinyl acetate copolymer resin, a polyamide resin, an acrylic resin, a vinylidene chloride resin, and a polycarbonate resin. The decorative molding 16 may have a thickness of preferably at least 0.3 mm and at most 0.8 mm for the metal material as one example and at least 1.0 mm and at most 3.5 mm for the plastic material as one example. The decorative molding having such a thickness has a reduced weight and a required rigidity.

Spacer

The glass plate with a resin frame 10 according to this embodiment has a spacer 18 disposed between the resin frame 14 and the decorative molding 16 as illustrated in FIG. 2.

The spacer 18 is disposed between the surface 14A of the resin frame 14 and the rear surface 16B of the decorative molding 16, more specifically, disposed between a sink mark portion 14B of the surface 14A of the resin frame 14 and the rear surface 16B. The spacer 18 is a member which is solid at room temperature. The spacer may be formed as a sheet member as one example. The spacer 18 may have a thickness of preferably at least 0.3 mm as one example. The spacer 18 having such a thickness has an advantage of decreasing the generation or the magnitude of a “creak sound” described later, reducing the generation of a “creak sound” in an effective way. Now, the material for the spacer 18 will be described. The spacer 18 may be disposed in a continuous manner or an intermittent manner along the decorative molding 16.

The spacer 18 may be made of at least material selected from a group comprising of a thermoplastic elastomer, rubber, a foamed resin and a metal, as one example.

Examples of the thermoplastic elastomer include a polystyrene-based thermoplastic elastomer (SBC, TPS), a polyolefin-based thermoplastic elastomer (TPO), a vinyl chloride-based thermoplastic elastomer (TPVC), a polyurethane-based thermoplastic elastomer (TPU), a polyester-based thermoplastic elastomer (TPEE, TPV), a polyamide-based thermoplastic elastomer (TPAE, TPA), and a polybutadiene-based thermoplastic elastomer (TPZ).

Examples of the rubber include natural rubber (NR), styrene-butadiene rubber (SBR), chloroprene rubber (CR), acrylonitrile rubber (NBR), butyl rubber (IIR), ethylene-propylene-diene rubber (EPDM), urethane rubber (U), and silicone rubber (Si).

Examples of the foamed resin include a urethane-based (PUR-based) resin, such as a flexible foam or a rigid foam, a polystyrene-based (PS-based) resin, such as a BPS foam, XPS foam or PSP foam, and an olefin-based resin, such as a PE foam, a PP foam or EVA foam. A PVC foam, an EPDM foamed resin or an acrylic foam may be applicable.

Examples of the metal include aluminum (AL), irons (including stainless steel), copper, brass, and lead.

The spacer 18 made as described above may be bonded to the rear surface 16B of the decorative molding 16 by use of a double-sided adhesive tape 20 to be positioned and attached to the rear surface 16B of the decorative molding 16 as one example.

It should be noted that the double-sided adhesive tape 20 is not an essential member in the glass plate with a resin frame 10. The use of the double-sided adhesive tape 20 is advantageous in terms of easy positioning of the spacer 18 to the decorative molding 16. When the double-sided adhesive tape 20 has a base material formed in a sheet shape so as to be usable as the spacer 18, the double-sided adhesive tape 20 per se functions as the spacer 18. In this case, in place of the double-sided adhesive tape 20, a one-sided adhesive tape may be used, which has an adhesive layer on a side facing the decorative molding 16. Alternatively, in place of the double-sided adhesive tape 20, a known adhesive may be used to bond the spacer 18 to the rear surface 16B of the decorative molding 16, or a combination of an engageable portion and an engaged portion, such as a combination of a concave portion and a convex portion, may be provided to position the spacer 18 to the decorative molding 16.

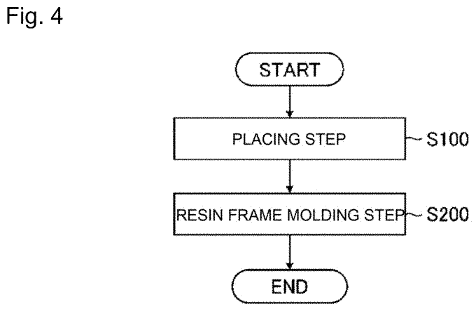

Process for Producing Glass Plate with Resin Frame Now, the process for producing a glass plate with a resin frame 10 according to an embodiment will be described in reference to the mold 30 illustrated in FIG. 3 and the flow chart illustrated in FIG. 4. Although it is shown in FIG. 3 that a molten resin 34, which is used to form the resin frame 1, has been injected into the cavity 32 of the mold 30, the following explanation will start with a state before the molten resin 34 has been injected.

The production process according to this embodiment is roughly divided into a placing step (S100) and a resin frame molding step (S200).

In the placing step (S100), the front surface 16A of the decorative molding 16 is placed on an inner wall 38 of a bottom mold 36 forming the mold 30 as illustrated in FIG. 3. The inner wall 38 has a concave portion 38A formed therein. The concave portion 38A functions as a placing portion dedicated to dispose the decorative molding 16 on the resin frame 14. In this case, the spacer 18 may be preferably to be previously bonded to the rear surface 16B of the decorative molding 16 by the double-sided adhesive tape 20.

Next, the peripheral edge area 13D of the glass plate 12 is placed at a certain position on the bottom mold 36. After that, the bottom mold 36 and a top mold 40 of the mold 30 are closed. In this manner, the cavity 32 is formed between the top mold and the bottom mold 36, accommodating the decorative molding 16 with the spacer 18 thereon and the peripheral edge area 13D of the glass plate 12 in the cavity 32. Thus, the placing step (S100) ends.

Next, in the resin frame molding step (S200), the molten resin 34 is injected into the cavity 32 through a resin injection port 42 formed in, for example, the top mold 40.

In one example, the resin injection port 42 is formed in the top mold 40 so as to be directed to the bottom mold 36. Thus, the molten resin 34 injected via the resin injection port 42 is injected into the cavity 32, directly striking the spacer 18. Since the molten resin 34 injected through the resin injection port 42 is injected into the cavity 32, directly striking the spacer 18, the decorative molding 16 is brought into close contact with the bottom mold 36, being pressed against the bottom mold via the spacer 18. This arrangement prevents a burr or the like from being formed at a boundary between the resin frame 14 and the decorative molding 16, which is advantageous. The molten resin 34 is gradually filled in the cavity 32. Finally, the cavity 32 is filled with the molten resin 34. After that, the top mold 40 and the bottom mold 36 are separated from each other. In this manner, the glass plate with a resin frame 10 illustrated in FIG. 1 is produced. Thus, the resin frame molding step (S200) ends.

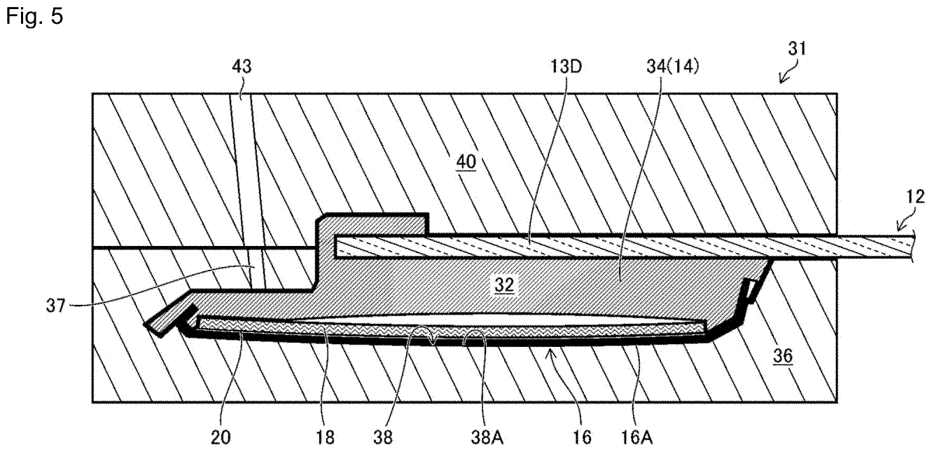

The bottom mold 36 may have a resin injection port 37 formed therein so as to communicate with the resin injection port 43 formed in the top mold 40 as in a modified mold 31 illustrated in a cross-sectional view of FIG. 5 such that the molten resin 34 is injected into the cavity 32 via the injection ports 43 and 37. The molten resin 34 injected from the resin injection port 43 may be injected into the cavity 32 without directly striking the spacer 18. When the molten resin 34 injected via the resin injection port 43 does not directly strike the spacer 18, the resin injection port 43 may be formed in the bottom mold 36.

Because the glass plate with a resin frame 10 produced in the production process described above is configured such that the spacer 18 is disposed between the resin frame 14 and the decorative molding 16, the provision of the spacer 18 effectively prevents a “creak sound” from being generated, which is different from the prior art.

Since the spacer 18 is a member which is solid at room temperature, it is possible to solve the problem in that the flow of a molten resin injected into the mold (the flow rate and the pressure of the molten resin) could cause a liquid material to adhere to the glass surface of another member to undergo adhesive failure as in the prior art.

Because the glass plate with a resin frame 10 thus produced reduces the filling amount of the molten resin 34 by the volume of the spacer 18, the resin frame 14 has a sink mark portion 14B formed on the surface 14A in a reduced dent depth. By this arrangement, the gap that is formed between the spacer 18 and the resin frame 14 by the provision of a sink mark portion 14B is decreased in comparison with the gap that has been formed between the spacer 18 and the resin frame 14 in the prior art, further reducing the generation of a “creak sound”.

Since the gap that is formed by the sink mark portion 14B is decreased as described above, it is possible to solve the problem in that the front surface 16A of the decorative molding 16 is distorted by the generation of the sink mark portion 14B. The decorative molding 16 in the shown example has a width W of at least 30 mm to improve the cosmetic appearance of the glass plate with a resin frame 10. Although conventional decorative moldings having such a width have been greatly distorted, the provision of the spacer 18 significantly reduces the generation of distortion in the shown example.

Thus, in accordance with the embodiments, it is possible to provide a glass plate with a resin frame for a vehicle window 10, having good quality, and a process for producing such a glass plate with a resin frame 10.

Since the spacer 18 in the shown example is a sheet member, the spacer can be uniformly attached to the rear surface 16B of a wide decorative molding 16. Thus, it is possible to effectively seal the gap formed between the spacer 16 and the resin frame 14, which is helpful to reduce the generation of a “creak sound”.

The spacer 18 is preferably made of a non-adhesive material to the resin frame 14. The non-adhesive material to the resin frame 14 means a material that is easily releasable from the material forming the resin frame 14, or does not adhere to or is difficult to adhere to a material forming the resin frame. Even if the sink mark portion 14B is formed in the resin frame 14, the use of such a spacer 18 prevents the spacer from being deformed, following the movement of the sink mark portion 14B. Thus, it is possible to reliably prevent the generation of distortion of the decorative molding 16, which is caused by the deformation of the spacer 18 following the distortion of the resin frame 14. Thus, it is possible to further improve the cosmetic appearance of the glass plate with a resin frame 10. Now, explanation will be made about the material for the spacer 18, which exhibits a non-adhesive property.

Case where resin frame is made of PVC The spacer 18 may be made of, for example, a polystyrene-based thermoplastic elastomer (SBC, TPS), a polyolefin-based thermoplastic elastomer (TPO), a polyurethane-based thermoplastic elastomer (TPU), a polyester-based thermoplastic elastomer (TPEE, TPV), a polyamide-based thermoplastic elastomer (TPAE, TPA), a polybutadiene-based thermoplastic elastomer (TPZ), styrene-butadiene rubber (SBR), chloroprene rubber (CR), acrylonitrile rubber (NBR), butyl rubber (IIR), ethylene-propylene-diene rubber (EPDM), urethane rubber (U), silicone rubber (Si), a flexible urethane foam, a hard urethane foam, a BPS foam, an XPS foam, a PSP foam, a PE foam, a PP foam, an EVA foam, a PF foam, an EPDM foam, an acrylic foam, aluminum (AL), iron (including SUS), copper, brass, and lead.

Case where Resin Frame is Made of TPE

The spacer 18 may be made of, for example, a vinyl chloride-based thermoplastic elastomer (TPVC), styrene-butadiene rubber (SBR), chloroprene rubber (CR), acrylonitrile rubber (NBR), butyl rubber (IIR), ethylene-propylene-diene rubber (EPDM), urethane rubber (U), silicone rubber (Si), a flexible urethane foam, a hard urethane foam, a BPS foam, an XPS foam, a PSP foam, an EVA foam, a PF foam, an EPDM foam, an acrylic foam, aluminum (AL), iron (including SUS), copper, brass, and lead.

The spacer 18 may be preferably a member, which is elastically deformable in the thickness direction thereof, as one example. In the case of such an elastically deformed spacer 18, the spacer is elastically deformed in the thickness direction by the pressure of the molten resin during injection of the molten resin, followed by being elastically restored, following the shrinkage of the molten resin. In this manner, the gap between the spacer 18 and the sink mark portion 14B of the resin frame 14 is lost or becomes minimum, further reducing the generation or the magnitude of a “creak sound”. The spacer 18 can be made of a material with a sound absorbing function to significantly reduce the generation of a “creak sound”.

### MODIFICATIONS

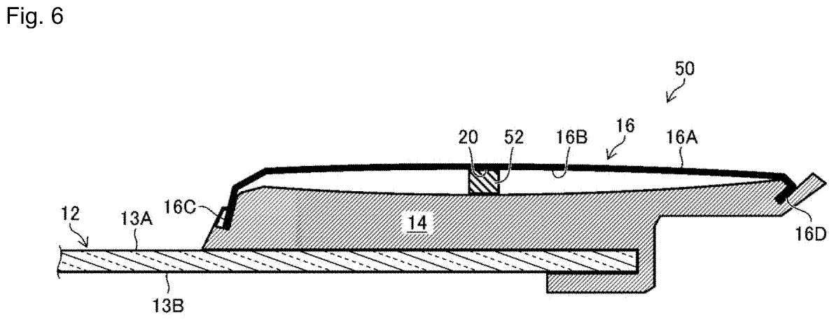

FIG. 6 is a cross-sectional view of the glass plate with resin frame 50 according to a first modification of the embodiment. In the explanation of the glass plate with a resin frame 50, parts or members identical or similar to those of the glass plate with a resin frame 10 illustrated in FIGS. 1 and 2 are indicated with like reference numerals, and explanation of these parts and members will be omitted.

The glass plate with a resin frame 50 illustrated in FIG. 6 is different from the glass plate with a resin frame 10 illustrated in FIGS. 1 and 2 in that the spacer 18 in a sheet shape is replaced by a spacer 52, which is formed in strap shape or block shape having a rectangular section. The spacer 52 is made of a member, which is solid at room temperature, and the spacer 52 is made of the same material as the spacer 18. The spacer 52 may be disposed in a continuous manner or an intermittent manner along the decorative molding 16 as in the spacer 18.

Even the use of the spacer 52 formed in such a strap shape can achieve a similar advantage to the spacer 18 formed in a sheet shape (reduction in the generation or the magnitude of a “creak sound”, or reduction in the generation or the magnitude of distortion). Although it is exemplified in FIG. 6 that the spacer 52 is rectangular in section, the shown example is merely one example. The spacer may be formed in, e.g., a circular shape or another shape in section.

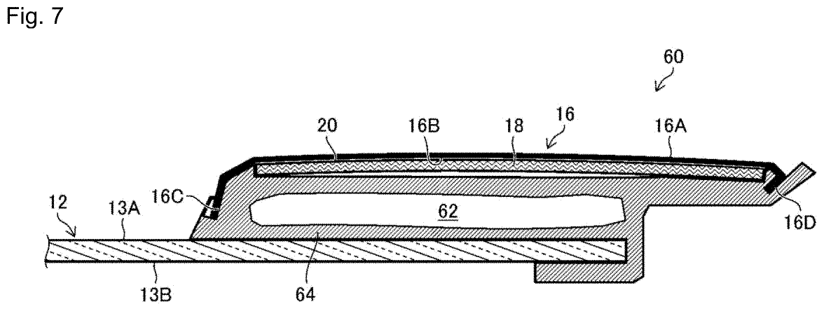

FIG. 7 is a cross-sectional view of the glass plate with a resin frame 60 according to a second modification of the embodiment. In the explanation of the glass plate with a resin frame 60, parts or members identical or similar to those of the glass plate with a resin frame 10 illustrated in FIGS. 1 and 2 are indicated with like reference numerals, and explanation of these parts and members will be omitted.

The glass plate with a resin frame 60 illustrated in FIG. 7 is different from the glass plate with a resin frame 10 illustrated in FIGS. 1 and 2 in that the glass plate according to the second modification includes a resin frame 64, which has a hollow portion 62 formed therein by gas injection.

The gas injection is a molding process, wherein a nitrogen gas is injected in a dwelling step after filling of a molten resin in injection molding, and the pressure is held from inside of the molten resin to reduce the generation of sink marks, warp or burrs.

In accordance with the glass plate with a resin frame 60 having the resin frame 64 molded by the gas injection, the generation of a sink mark portion formed on the resin frame 64 is decreased to effectively reduce the generation or the magnitude of a “creak sound”. The thickness of the spacer 18 is decreased by the volume expanded by the gas injection, reducing the weight of the glass plate with a resin frame 60.

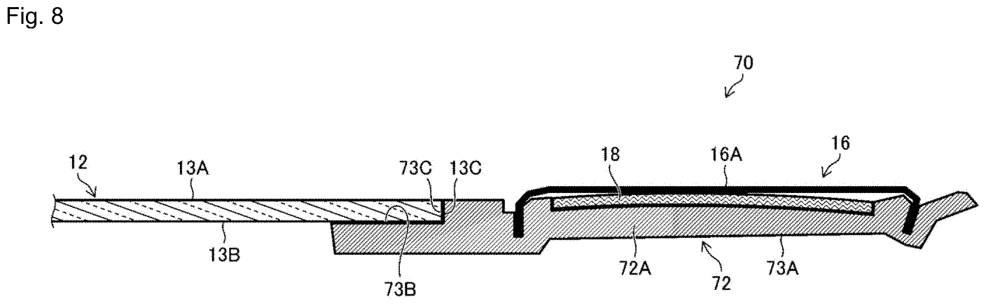

FIG. 8 is a cross-sectional view of the glass plate with a resin frame 70 according to a third modification of the embodiment. In the explanation of the glass plate with a resin frame 70, parts or members identical or similar to those of the glass plate with a resin frame 10 illustrated in FIGS. 1 and 2 are indicated with like reference numerals, and explanation of these parts or members will be omitted.

The glass plate with a resin frame 70 illustrated in FIG. 8 is different from the glass member with a resin frame 10 illustrated in FIGS. 1 and 2 in that the glass plate with a resin frame 70 has a resin frame 72 formed as a two-side molding while the resin frame 14 of the glass plate with a resin frame 10 is formed as a three-side molding.

The two-side molding means that the resin frame 72 includes two inner surfaces 73B and 73C brought into contact with the inner side surface 13B and the end surface 13C of the glass plate 12, respectively, and that the resin frame 72 is configured so as not to project from the outer side surface 13A of the glass plate 12. The two-side molding permits a vehicle body to have a flush surface because the resin frame 72 does not project outside of the vehicle body in comparison with the three-side molding.

In the glass plate with a resin frame 70 configured as the two-side molding, the dent depth of the sink mark portion 14B formed on the resin frame 72 is reduced in comparison with the glass plate with a resin frame 10 configured as the three-side molding. The reasons are as follows:

When the resin frame 14 as the three-side molding is shrunk after injection molding, the sink mark portion 14B is not formed on the inner surface 15A in touch with the glass plate 12 having a high rigidity, but is formed on the surface 14A opposite to the inner surface 15A (see FIG. 2). In the two-side molding in comparison with the three-side molding, the glass plate 12 is absent in the thickness direction of a main part 72A of the resin frame 72 to prevent the resin frame 72 from being influenced by the glass plate 12. As a result, the resin frame 72 has a sink mark portion mainly formed on the entire surface or the inner surface 73A thereof. Thus, the gap formed between the decorative molding 16 and the resin frame 72 is decreased in comparison with the three-side molding.

Even the two-side molding can reduce the generation or the magnitude of a “creak sound” in comparison with the conventional two-side moldings by an arrangement wherein the spacer 18, which is solid at room temperature, is disposed between the resin frame 72 and the decorative molding 16.

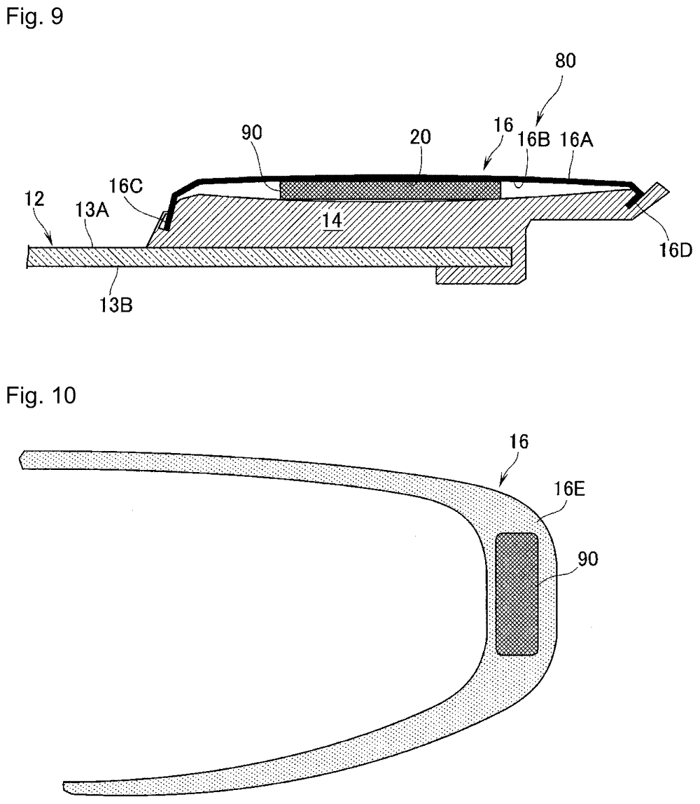

FIG. 9 is a cross-sectional view of the glass plate with a resin frame 80 according to a fourth modification of the embodiment. In the explanation of the glass plate with a resin frame 80, parts or members identical or similar to those of the glass plate with a resin frame 10 illustrated in FIGS. 1 and 2 are indicated with like references, and explanation of these parts and members will be omitted.

The glass plate with a resin frame 80 illustrated in FIG. 9 is different from the glass plate with a resin frame 10 illustrated in FIGS. 1 and 2 in that the glass plate with a resin frame 80 includes a wide area 16E on at least a portion of the decorative molding 16 in an area indicated by reference symbol 16E in FIG. 1, the wide area having a width of at least 30 mm in a longitude direction of a vehicle as seen in front view, and the spacer 18 in the sheet shape is replaced by a primer 90 applied on a surface of the resin frame 72 facing the decorative molding 16. The primer 90 is cured after application, serving as a member, which is solid at room temperature.

The primer 90 may be made of a mixture of one or more materials of, e.g., polyurethane type, polyester type, polyamide type, A-phenol type, acrylic type, epoxy type, cyanoacrylate type, and rubber type. These materials may be used as they are, in a state after being dissolved in a solvent, or as so-called emulsion after being dispersed in water.

The primer 90 may be preferably applied to an area occupying at least 50% and at most 80% of the area of the wide area 16E on the surface of the decorative molding 16 facing the resin frame 72. When the application area of the primer 90 occupies at least 50% of the area of the wide area 16E, the generation or the magnitude of a “creak sound” is effectively reduced since the gap formed between the decorative molding 16 and the resin frame 72 is sufficiently decreased. When the application area of the primer 90 occupies at most 80% of the area of the wide area 16E, the glass plate with a resin frame is provided to have good quality because the decorative molding 16 is not distorted even if the resin frame 72 is heat-shrunk during molding of the resin frame 72.

The area where the primer 90 is applied to the wide area 16E is preferably an area, which overlaps with the wide area 16E as seen in front view, and where the resin frame 72 has a thickness of at most 3.0 mm. The thickness of the resin frame 72 means the distance between an outer surface of the glass plate 12 and an outer surface of the resin frame 72.

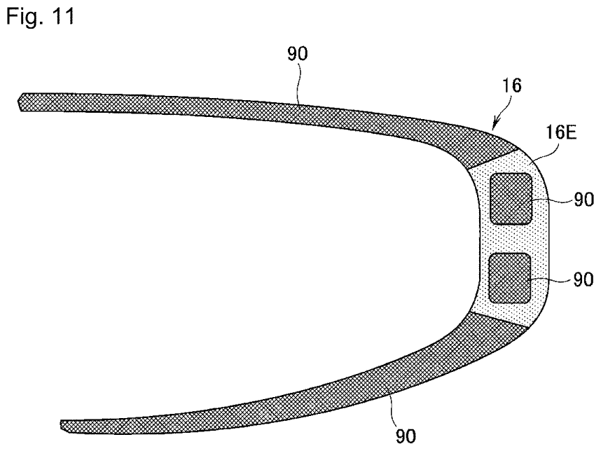

FIGS. 10 and 11 are a front view of the decorative molding according to a fourth modification, and a front view of the decorative molding according to another example of the fourth modification, respectively. FIGS. 10 and 11 illustrate the decorative moldings seen from inside of a vehicle. The respective decorative moldings illustrated in FIGS. and 11 are applied to a window of a vehicle opposite to the window where the decorative molding is applied to the glass plate with a resin frame for a vehicle 10 illustrated in FIG. 1. As illustrated in FIG. 10, the application area where the primer 90 is applied to the wide area 16E is present at a single position or at each of plural positions as illustrated in FIG. 11 so long as the application area occupies at least 50% and at most 80% of the area of a wide area 16E. As illustrated in FIG. 11, a primer 90 may be also applied to an area other than the wide area 16E on the decorative molding 16.

Even when the primer 90 is applied to an area occupying at least 50% and at most 80% of the area of the wide area 16E of the decorative molding 16, it is possible to achieve an advantage similar to the spacer 18 in a sheet shape (a reduction in the generation or the magnitude of a “creak sound”, and a decrease in the generation or the magnitude of distortion).

The glass plate assembly with a resin frame and the method for producing a glass plate according to the present invention have been described in reference to respective embodiments. The present invention is not limited to the above-mentioned embodiments. Various improvements or modifications can be made without departing from the spirit of the present invention.

### EXPLANATION OF REFERENCE SYMBOLS

10: Glass Plate with Resin Frame, 12: Glass Plate, 14: Resin Frame, 16: Decorative Molding, 16E: Wide Area, 18: Spacer, 20: Double-Sided Adhesive Tape, 30: Mold, 31: Mold, 32: Cavity, 34: Molten Resin, 36: Bottom Mold, 37: Resin Injection Port, 38: Inner Surface, 40: Top Mold, 42: Resin Injection Port, 43: Resin Injection Port, 50: Glass Plate with Resin Frame, 52: Spacer, 60: Glass Plate with Resin Frame, 62: Hollow Portion, 64: Resin Frame, 70: Glass Plate with Resin Frame, 72: Resin Frame, 80: Glass Plate with Resin Frame, 90: Primer

What is claimed is:

1. A glass plate with a resin frame for a vehicle window, comprising:
a glass plate having a peripheral edge area;
a resin frame disposed on the peripheral edge area; and
a decorative molding disposed on the resin frame;
wherein the resin frame is molded to the glass plate and the decorative molding as one unit; and
wherein a spacer is disposed between the resin frame and the decorative molding, the spacer being solid at room temperature.

2. The glass plate according to claim 1, wherein the spacer comprises a sheet member.

3. The glass plate according to claim 1, wherein the spacer comprises at least one material selected from a group comprising a thermoplastic elastomer, rubber, a foamed resin, and metals.

4. The glass plate according to claim 3, wherein the spacer comprises a material having a non-adhesive property to the resin frame.

5. The glass plate according to claim 1, wherein the decorative molding has a wide area of at least 30 mm in at least one portion thereof.

6. The glass plate according to claim 1, wherein the decorative molding comprises a metal material having a thickness of at least 0.3 mm and at most 0.8 mm, or
wherein the decorative molding comprises a plastic material having a thickness of at least 1.0 mm and at most 3.5 mm.

7. The glass plate according to claim 1, wherein the spacer has a thickness of at least 0.3 mm.

8. The glass plate according to claim 5, wherein a primer, in place of the spacer, is applied to an area occupying at least 50% and at most 80% of an area of the wide area on a surface of the decorative molding facing the resin frame.

9. The glass plate according to claim 5, wherein a primer, in place of the spacer, is applied to an area, which overlaps with the wide area as seen in front view, and where the resin frame has a thickness of at most 3.0 mm.

10. A process for producing a glass plate with a resin frame for a vehicle window, the resin frame being molded to the glass plate and a decorative molding as one unit, comprising:
preparing the decorative molding so as to have a first surface and a second surface opposite to the first surface;
attaching a spacer to the second surface of the decorative molding, the spacer being solid at room temperature;
placing the decorative molding in a mold such that the first surface of the decorative molding faces the mold;
placing the glass plate in the mold; and
injecting a molten resin into a cavity space in the mold to produce the glass plate with the resin frame for the vehicle window such that the spacer is disposed between the resin frame and the decorative molding.

11. The process according to claim 10, wherein the spacer comprises a sheet member.

12. The process according to claim 10, further comprising bonding the spacer to the second surface of the decorative molding by an adhesive tape to attach the spacer to the decorative molding with the spacer being positioned to face the second surface of the decorative molding.

13. The process according to claim 10, wherein the decorative molding has a wide area of at least 30 mm in at least one portion thereof.

14. The process according to claim 10, wherein the decorative molding comprises a metal material having a thickness of at least 0.3 mm and at most 0.8 mm, or wherein the decorative molding comprises a plastic material having a thickness of at least 1.0 mm and at most 3.5 mm.

15. The process according to claim 10, wherein the resin frame has a thickness of at least 2.5 mm in an area overlapping with the decorative molding as seen in front view.
